(19) United States
(12) Patent Application Publication
(10) Pub. No.: US 2003/0095610 A1
(43) Pub. Date: May 22, 2003

(54) Method, device and computer program product for a demodulator using a fuzzy adaptive filter (FAF) and decision feedback

(76) Inventors: Qilian Liang, San Diego, CA (US); Frank Onochie, S. Escondido, CA (US); Romeo Velarde, San Diego, CA (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/978,291

(22) Filed: Oct. 16, 2001

(51) Int. Cl. H04L 27/06

(52) U.S. Cl. 375/316; 375/340; 375/332

(57) ABSTRACT

A method, device and computer program product for a demodulator 200 for use in a communications channel 110, including a channel estimator section 204 configured to receive a modulated signal r[k] over the communications channel 110 and generate reference symbols based on the modulated signal r[k]; a fuzzy adaptive filter (FAF) parameter determination section 206 coupled to the channel estimator section 204 and configured to receive the modulated signal r[k] and the reference symbols and generate signal samples based on the modulated signal r[k] and the reference symbols; and a detector section 208 coupled to the FAF parameter determination section 206 and configured to receive the signal samples and generate a soft decision signal and a hard decision signal based on the signal samples.

### BACKGROUND OF THE INVENTION

1. Field of the Invention

The present invention generally relates to satellite communications systems and more particularly to a method, device and computer program product for a demodulator using fuzzy adaptive filter (FAF) and decision feedback. The present invention includes use of various technologies described in the references identified in the appended LIST OF REFERENCES and cross-referenced throughout the specification by numerals in brackets corresponding to the respective references, the entire contents of all of which are incorporated herein by reference.

2. Discussion of the Background

In recent years, communications systems, such as satellite communications systems have been developed. Such systems typically employ a demodulator included in a transceiver of a device coupled to a communications channel, such as a satellite downlink communications channel, etc. In this respect Wang and Mendel [1] propose a fuzzy adaptive filter (FAF)-based equalizer for a time-invariant channel with Binary Phase Shift Keying (BPSK) modulation. Wang and Mendel uniformly classify the feature domain and use recursive least square (RLS) and least mean square (LMS) to design the system parameters. Sarwal and Srinath [2] observe that a linear transversal filter requires a much larger training set to achieve a same error rate as compared to that of a FAF equalizer.

Lee [3] extended the technique of Wang and Mendel to a complex domain for Quadrature Amplitude Modulation (QAM) constellation channel equalization. Patra and Mulgrew [4] use an FAF to implement a Bayesian equalizer for BPSK modulation. All the above techniques typically are employed for time-invariant channels. Recently, Liang and Mendel studied time-varying channels and proposed a type-2 FAF for channel equalization [5] and co-channel interference elimination [6].

Beidas [9] proposes demodulators based on Wiener interpolation with decision feedback and a linear interpolation with decision feedback techniques. Background art FIGS. 12 and 13 illustrate typical demodulator schemes based on Wiener interpolation with decision feedback and linear interpolation with decision feedback, respectively, as proposed by Beidas [9].

Many of the above techniques, however, typically employ a large number of training data in order to achieve adequate demodulator performance. In addition, many of the above techniques suffer from inadequate demodulator performance in fading channel, such as a Rician fading channel, etc., which has lots of channel impairments (e.g., adjacent channel interferences (ACI), phase noise, IQ mismatch, timing and frequency errors, DC offset, etc.).

Therefore, there is a need for a method, device and computer program product for a demodulator that employs reduced training data and that may be used in a fading channel, as compared to conventional demodulators.

### SUMMARY OF THE INVENTION

The above and other needs are addressed by the present invention, which provides an improved device, system and computer program product for a demodulator including a fuzzy adaptive filter (FAF) and/or decision feedback and that employs reduced training data and that may be used in an impaired channel, as compared to conventional demodulators.

Accordingly, in one aspect of the present invention there is provided an improved method, device and computer program product for a demodulator for use in a communications channel, including a channel estimator section configured to receive a modulated signal over the communications channel and generate reference symbols based on the modulated signal; a fuzzy adaptive filter (FAF) parameter determination section coupled to the channel estimator section and configured to receive the modulated signal and the reference symbols and generate signal samples based on the modulated signal and the reference symbols; and a detector section coupled to the FAF parameter determination section and configured to receive the signal samples and generate a soft decision signal and a hard decision signal based on the signal samples.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a system diagram illustrating an exemplary satellite communications system, which may employ a demodulator including a fuzzy adaptive filter (FAF) and/or decision feedback, according to the present invention;

FIG. 2 is a block diagram illustrating the demodulator including a fuzzy adaptive filter (FAF) and/or decision feedback, which may be used in the system of FIG. 1, according to the present invention;

FIG. 3 is a block diagram of a phase noise model used to evaluate the performance of the demodulator of FIG. 2, according to the present invention;

FIG. 4 is a graph illustrating a measured frequency response used to evaluate the performance of the demodulator of FIG. 2, according to the present invention;

FIG. 5 is a block diagram of an IQ mismatch model used to evaluate the performance of the demodulator of FIG. 2, according to the present invention;

FIGS. 6a-6d are graphs illustrating the performance of the demodulator of FIG. 2 with no receiver impairments, according to the present invention;

FIG. 7 is a graph illustrating the performance of the demodulator of FIG. 2 with receiver impairments, according to the present invention;

FIG. 8 is a graph illustrating the sensitivity of the demodulator of FIG. 2 to frequency errors, according to the present invention;

FIG. 9 is a graph illustrating the sensitivity of the demodulator of FIG. 2 to timing errors, according to the present invention;

FIG. 10 is a graph illustrating the performance of the demodulator of FIG. 2 in single versus multi-burst detection, according to the present invention;

FIG. 11 is an exemplary computer system, which may be programmed to perform one or more of the processes of the present invention;

FIG. 12 illustrates a background art demodulator scheme based on Wiener interpolation with decision feedback; and

FIG. 13 illustrates a background art demodulator scheme based on linear interpolation with decision feedback.

### DETAILED DESCRIPTION OF THE PREFERRED EMBODIMENTS

A device, method and computer program product for a demodulator including a fuzzy adaptive filter (FAF) and/or decision feedback, are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

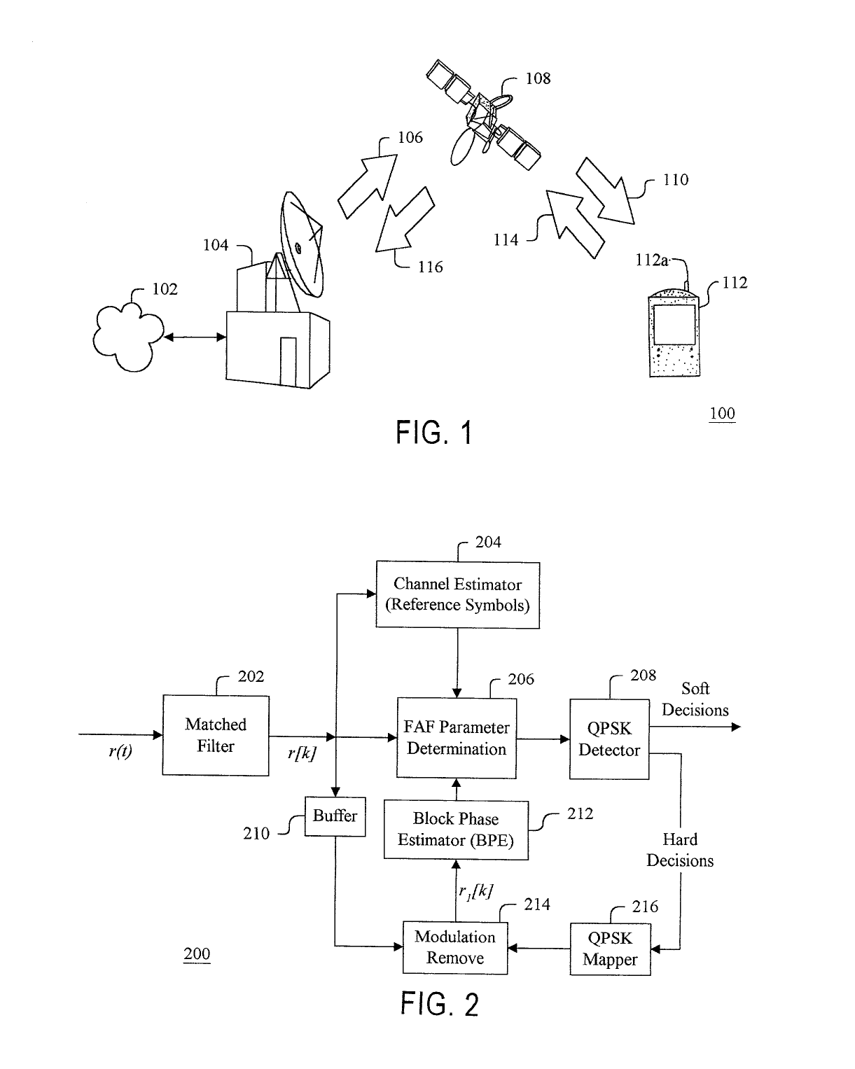

Referring now to the drawings, wherein like reference numerals designate identical or corresponding parts throughout the several views, and more particularly to FIG. 1 thereof, there is illustrated a system 100 in which a data packet demodulator using fuzzy adaptive filter (FAF) and/or decision feedback according to the present invention may be employed. In FIG. 1, in the system 100 according to the present invention, a network operations control center 104 transmits information on satellite uplink channel 106, such as received from sources 102 (e.g., the Internet, an Intranet, content sources, etc.), to a satellite 108. The satellite 108 then transmits modulated information (e.g., using Quadrature Phase Shift Keying (QPSK), etc.) on a device downlink channel 110 to a device 112, such as a Bluetooth [12] enabled: repeater, personal digital assistant (PDA), personal computer, television, Internet appliance, cellular phone, set-top box, etc.

The device 112 includes an antenna 112a and a satellite communications transceiver (not shown) and thus is able to receive the modulated information on the downlink channel 110. Such a satellite communications transceiver may include the packet data demodulator using fuzzy adaptive filter (FAF) and/or decision feedback according to the present invention, as will be further described in detail with respect to FIG. 2, to demodulate the information received on the downlink channel 110.

The device 112 may make requests for information and/or transmit information via a device uplink channel 114. The satellite 118 receives information transmitted from the device 112 on the device uplink channel 114 and transmits the received information to the network operations control center 104 via a satellite downlink channel 116. The network operations control center 104 then may forward the information received on the satellite downlink channel 116 from the satellite 118 to the sources 102 (e.g., the Internet, an Intranet, content sources, etc.).

With the above-noted system 100, video download, audio download, graphics download, file download, pay per view, video-on-demand, audio-on-demand, Internet surfing, e-mail, voice communications, text communications, paging functions, Bluetooth [12] repeater functions, Bluetooth [12] device functions, etc., may be implemented on the device 112. One or more interface mechanisms may be used in the system 100, for example, including Internet access, telecommunications in any form (e.g., voice, modem, etc.), wireless communications media, etc., via the communication network 104 and the satellite communications channels 106, 110, 114, and 116. The system 100 information also may be transmitted via direct mail, hard copy, telephony, etc., when appropriate.

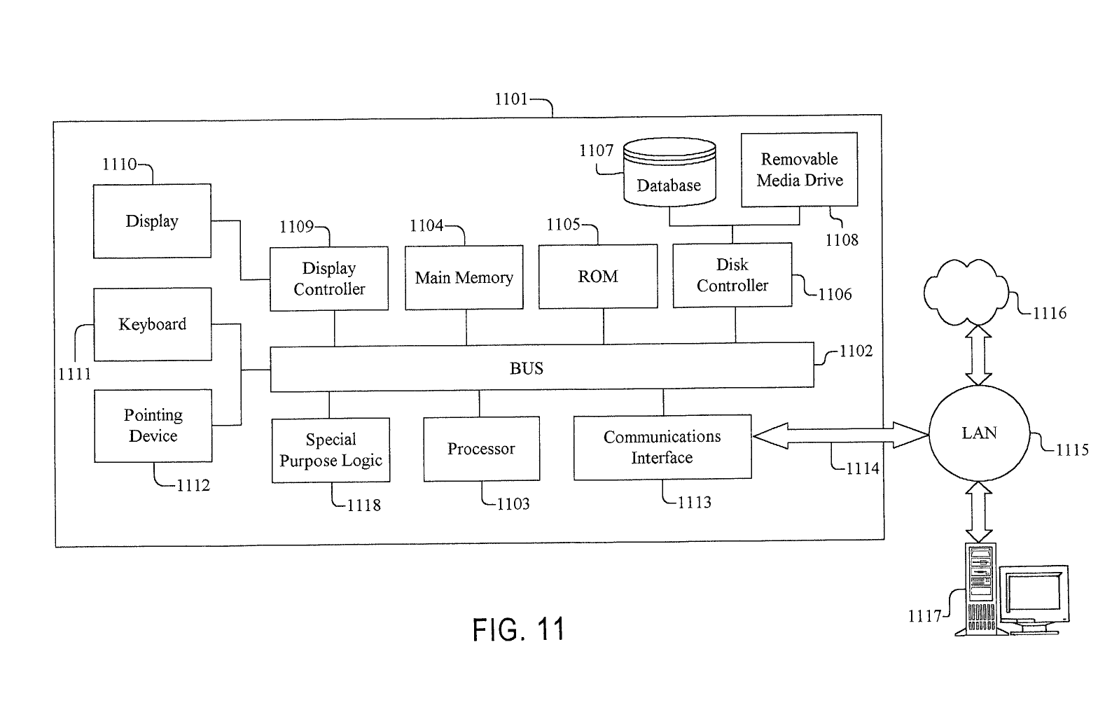

Accordingly, the systems 104, 108 and 112 may include any suitable servers, workstations, personal computers (PCs), personal digital assistants (PDAs), Internet appliances, set top boxes, other devices, etc., capable of performing the processes of the present invention. The systems 104, 108 and 112 may communicate with each other using any suitable protocol and, for example, via the communications network 102 and the communications channels 106, 110, 114 and 116 and may be implemented using the computer system 1101 of FIG. 11, for example.

It is to be understood that the system in FIG. 1 is for exemplary purposes only, as many variations of the specific hardware used to implement the present invention are possible, as will be appreciated by those skilled in the relevant art(s). For example, the functionality of the one or more of the systems 104 and 108 may be implemented via one or more programmed computers or devices. To implement such variations as well as other variations, a single computer (e.g., the computer system 1101 of FIG. 11) may be programmed to perform the special purpose functions of, for example, the systems 104 and 108 shown in FIG. 1. On the other hand, two or more programmed computers or devices, for example as in shown FIG. 11, may be substituted for any one of the systems 104, 108 and 112. Principles and advantages of distributed processing, such as redundancy, replication, etc., may also be implemented as desired to increase the robustness and performance of the system 100, for example.

The communications network 102 may be implemented via one or more communications networks (e.g., the Internet, an Intranet, a wireless communications network, a satellite communications network, a cellular communications network, a hybrid network, etc.), as will be appreciated by those skilled in the relevant art(s). In a preferred embodiment of the present invention, the communications network 102 and the communications channels 106, 110, 114 and 116 and the systems 104, 108 and 112 preferably use electrical, electromagnetic, optical signals, etc., that carry digital data streams, as are further described with respect to FIG. 11. The demodulator according to the present invention will now be described in detail in the following sections and with reference to FIGS. 1-13.

Physical Layer Baseline

A physical layer baseline design is given in [7, 8]. The new design allows for an L1 frame duration of 40 ms with a total of 18 L1 bursts per frame in the forward link 110. The modulation is Quadrature Phase Shift Keying (QPSK) with a symbol-rate of 54 k symbols/sec and with a channel spacing of 75 KHz. Each Packet Data Channel (PDCH) burst has 120 complex-valued symbols or 240 bits including a total of 12 unique reference symbols arranged in a set of 6 with each set containing 2 reference symbols. In the present invention, the reference symbols used were the same as specified in a current air interface ICO AI 05.02. The specified environment used in the present invention is given in Table 1 below.

TABLE 1
Specified environment

| | Carrier/Multipath | Fading BW | Static |
|---|---|---|---|
| Environment | ratio K (dB) | (Hz) | link margin |
| Land semi-fixed | 12 | 1 Hz | [4 dB] |
| Land open | 12 | 20 Hz | [5 dB] |
| Maritime | 9 | 1 Hz | [3 dB] |
| Land mobile | 12 | 200 Hz | [5 dB] |

Base-band Equivalent Model [9]

The matched filter output when sampled in time-synchronism can be modeled as:

r[k]=bₖ·u[k]+n[k] (1)

where bₖ is the kth QPSK information symbol, u[k] is a complex-valued Gaussian process with mean and variance:

$$\begin{matrix}E \{ u [ k ] \} = \sqrt{{γ}_{b} \cdot \frac{{K}_{rician}}{{K}_{rician} + 1}} \cdot {ⅇ}^{j2π0 .7 {f}_{D} \cdot {kT}_{s}} & ( 2 ) \\ {σ}_{u}^{2} = {γ}_{b} \cdot \frac{1}{{K}_{rician} + 1} & ( 3 )\end{matrix}$$

The accompanying noise at the matched filter output n[k] is a zero-mean white Gaussian sequence with variance that is normalized to unity without loss in generality. Equation (1) above is derived based on the following discussion, wherein:

r(t)=c(t)·s(t)+n(t) (a)

where the accompanying noise n(t) in the received signal r(t) is Additive White Gaussian Noise (AWGN) with Power Spectral Density level of N₀/2 (Watts/Hz) in the in-phase (I) and quadrature (Q) components.

The channel complex gain is specified to follow a Rician fading with K_{rician} as the ratio of direct path power to that of the multipath, and ƒ_{D} as the doppler spread or single-sided fading bandwidth. Also, the direct path is shifted in frequency by a factor of 0.7 ƒ_{D}. Such a shift c(t) can be mathematically described as:

$$c ( t ) = ( \sqrt{\frac{{K}_{rician}}{{K}_{rician} + 1}} \cdot {ⅇ}^{j2π0 .7 {f}_{D} t} + \sqrt{\frac{1}{{K}_{rician} + 1}} \cdot g ( t ) ) \qquad ( b )$$

where g(t) is a complex zero-mean Gaussian fading process with variance of unity. The auto-correlation function associated with this channel is given by:

$${R}_{c} ( τ ) = \frac{{K}_{rician}}{{K}_{rician} + 1} \cdot {ⅇ}^{j2π0 .7 {f}_{D} τ} + \frac{1}{{K}_{rician} + 1} \cdot {J}_{0} ( 2 π {f}_{D} τ ) \qquad ( c )$$

where J₀(x) is the Bessel function of the zeroth order.

The transmitted signal s(t) is represented as:

s(t)=\tilde{s}_{QPSK}(t−εTₛ)·e^{J(2πΔƒt+θ}^{_{c}}) (d)

where ε denotes the normalized timing offset, Δƒ is the carrier frequency drift introduced by the channel, θ_{c} is the initial carrier phase assumed to be uniformly distributed over [−π, π) and Tₛ⁻¹ is the symbol rate. The modulation employed is QPSK and is mathematically described as:

$${\tilde{s}}_{QPSK} ( t ) = \sqrt{S} {\sum }_{k} {α}_{k} \cdot h ( t - {kT}_{s} ) \qquad ( e )$$

where {αₖ} are the data symbols which are conveyed via phase information αₖ=e^{J}^{^{θ}}^{ₖ} and:

$${θ}_{k} ∈ \{ \frac{2 π \cdot i}{4} ; i = 0 , 1 , 2 , 3 \} \qquad ( f )$$

The pulse shaping is achieved through the root-raised cosine function with a roll-off parameter of 0.4 and is expressed in the time domain as:

$$h ( t ) = \frac{{T}_{s} / 4 α}{π ( {( {T}_{s} / 4 α )}^{2} - {t}^{2} )} \{ cos ( \frac{( 1 + α ) π}{{T}_{s}} t ) + \frac{{T}_{s}}{4 α \cdot t} sin ( \frac{( 1 - α ) π}{{T}_{s}} t ) \} \qquad ( g )$$

The root-raised cosine is known to be a tightly band-limited pulse that satisfies the Nyquist criterion of zero inter-symbol interference (ISI) when sampled in time synchronism given by:

$${\int }_{- ∞}^{∞} h ( t ) \cdot h ( t + {nT}_{s} ) ⅆ t = \{ \begin{matrix}{T}_{s} , & n = 0 \\ 0 , & n = \pm 1 , \pm 2 , \pm 3 , Λ\end{matrix} \qquad ( h )$$

We also define γ_{b} as the per-bit signal-to-noise ratio (SNR) given by:

$${γ}_{b} = \frac{1}{2} \cdot \frac{{ST}_{s}}{{N}_{0}} \qquad ( i )$$

Demodulator Schemes

Introduction

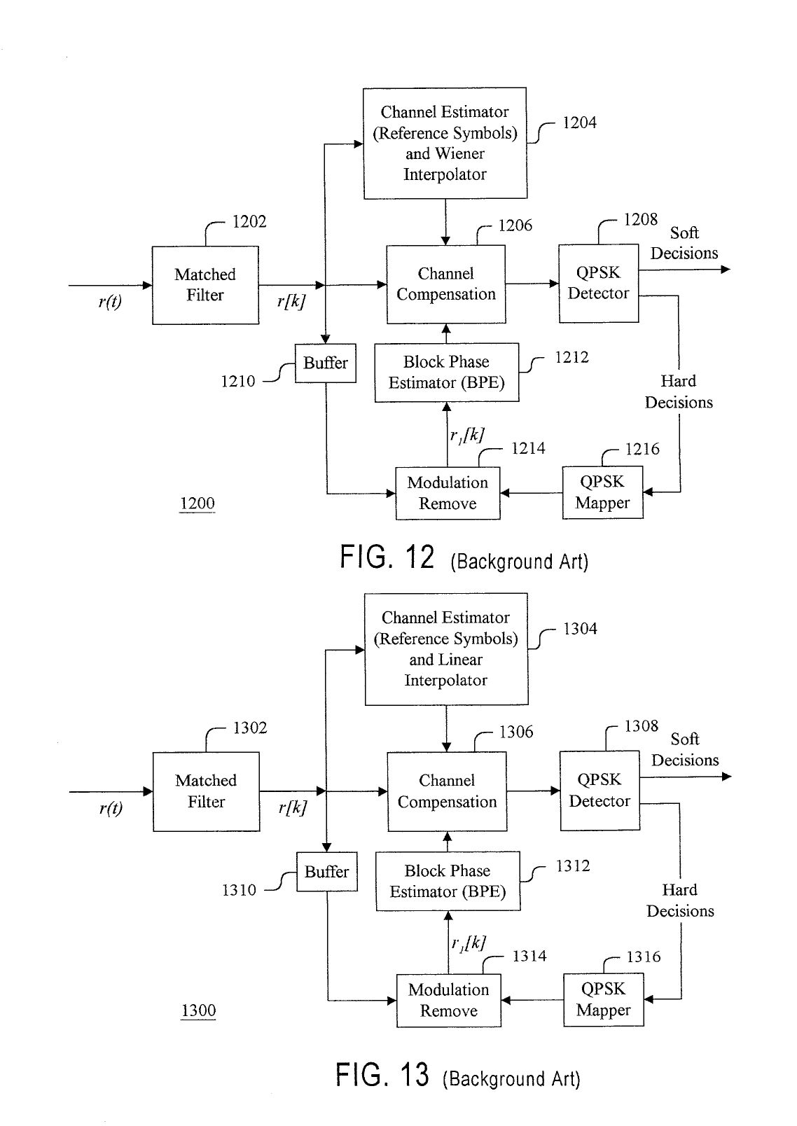

The various demodulator schemes described herein with respect to Background Art FIGS. 12 and 13 utilize one or two stages of channel estimation (elements 1204 and 1304 and 1212 and 1312) and compensation (elements 1206 and 1306) prior to final signal detection (elements 1208 and 1308). In these schemes, the second-stage channel estimation 1212 and 1312 is based on the Block-Phase estimation (BPE) Algorithm. The tentative hard decisions are used for modulation removal 1214 and 1314 prior to second-stage channel estimation 1212 and 1312. This approach is known to offer significant improvement compared with conventional modulation removal based on raising the received signal to the fourth power, for QPSK. The schemes of Background Art FIGS. 12 and 13 further include QPSK mappers 1216 and 1316, buffers 1210 and 1310 and matched filters 1202 and 1302 and may be implemented as taught by Beidas [9] and Liang and Mendel [5].

Block Phase Estimation (BPE) Algorithm

In the BPE (elements 1212 and 1312), originally proposed in [4], the burst is segmented into K blocks of size L during which the phase variation is considered small. Within this block, the phase estimate at the middle of the block is evaluated as follows:

$${\hat{θ}}_{k} = {tan}^{- 1} ( \frac{{\sum }_{n ∈ L} Im \{ {r}_{1} [ n ] \}}{{\sum }_{n ∈ L} Re \{ {r}_{1} [ n ] \}} ) ; k = 0 , 1 , Λ , K - 1 \qquad ( j )$$

where r₁[k] is the sequence of complex-valued modulation-removed signals. A phase unwrapping algorithm is implemented next because of the sharp discontinuities inherent in the inverse tangent function. To obtain the intermediate values of the fading channel phase at every symbol, a linear interpolation is made between the phases estimated in (j) after phase unwrapping. The choice of parameters of the block size and the number of blocks that need to be optimized is determined via simulation. Namely, for slow fading a larger block size is desired as the quality of phase estimate in the middle of the blocks improves. However, for the fast fading case, a smaller block size is desired as the condition of a constant phase value during a block is less satisfied.

Scheme 1: Wiener Interpolator and Block Phase Estimation with Decision Feedback

This scheme is shown in Background Art FIG. 12 and was developed for User Terminal Circuit-switched applications [9]. In this scheme, the matched filter 1202 complex-valued output samples are input to a Wiener estimator and interpolator 1204. The initial channel estimates are used to obtain tentative decisions, which are fed back to be used by the second channel estimator, the BPE 1212. The BPE 1212 estimates are then used to compensate, via the channel compensation 1206, the distorted signals prior to final signal detection at the QPSK detector 1208.

Summary of the Algorithm

The two reference symbols in each set are averaged to provide an estimate of the channel complex gain or:

$$\tilde{r} [ {k}_{0} + l \cdot M ] = \frac{1}{2} \cdot [ {\sum }_{t = 0}^{1} r [ {k}_{0} + l \cdot M + ( i - 1 ) ] \cdot exp ( - j \cdot {θ}_{ref} [ i ] ) ] \qquad ( k )$$

where in this case k₀=9, M=20, and l=0, 1, Λ, 5. Relation (k) results in a group of six reference symbols that span the entire burst. These individual reference symbols are separated by MTₛ and each is at an SNR level of 4γ_{b}.

Using those reference symbols computed in (k), v[k], a linear Minimum Mean Squared Error (MMSE)-based estimate of the channel complex gain u[k] at the kth symbol can be represented as:

$$v [ k ] = \hat{u} [ k ] = {\sum }_{i = 0}^{5} {h}_{i}^{*} [ k ] \cdot \tilde{r} [ {k}_{0} + i \cdot M ] = {{h}^{H}}^{ρ} [ k ] \cdot {r}^{ρ} \qquad ( 1 )$$

where in matrix form notation is given by:

$${r}^{ρ} = [ \begin{matrix}\tilde{r} [ {k}_{0} ] \\ \tilde{r} [ {k}_{0} + M ] \\ M \\ \tilde{r} [ {k}_{0} + 5 \cdot M ]\end{matrix} ] \qquad ( m )$$

In (m), there are six filter coefficients that need to be determined based on minimizing the mean-squared error between the channel complex gain and its estimate at the kth symbol or:

$$E \{ {\vert u [ k ] - v [ k ] \vert}^{2} \} \qquad ( n )$$

The set of relations that are satisfied by the optimal coefficients can be shown to be:

$$R \cdot {{h}^{ρ}}_{opt} [ k ] = {w}^{ρ} [ k ] \qquad ( o )$$

where the R is a 6×6 auto-correlation matrix of the observables given by:

$$R = E \{ {r}^{ρ} \cdot {{r}^{H}}^{ρ} \} \qquad ( p )$$

and [symbol] [k] is a 6×1 covariance vector given by:

$${w}^{ρ} [ k ] = E \{ {u}^{*} [ k ] \cdot {r}^{ρ} \} \qquad ( q )$$

The condition in (o) is actually an implementation of the orthogonality principle between the data and the error in the estimate that is associated with the linear MMSE solution [9]. The solution to (o) is given by:

$${{h}^{ρ}}_{opt} [ k ] = {R}^{- 1} \cdot {w}^{ρ} [ k ] \qquad ( r )$$

The amount of residual error contained in the estimate (r) when the optimal filter coefficients are used is quantified as:

$$min E \{ {\vert u [ k ] - v [ k ] \vert}^{2} \} = {γ}_{b} - {{w}^{H}}^{ρ} [ k ] \cdot {R}^{- 1} \cdot {w}^{ρ} [ k ] \qquad ( s )$$

For the Rician fading case, the individual components of the arrays R and [symbol] [k] are obtained as:

Rₗₘ=E{\tilde{r}[k₀+l·M]·\tilde{r}*[k₀+m·M]}

$$\begin{matrix}= {γ}_{b} \cdot {\vert \tilde{b} \vert}^{2} \cdot {\tilde{R}}_{c} ( ( l - m ) \cdot {MT}_{s} ) + 0.25 \cdot {δ}_{lm} and & ( t ) \\ {w}_{l} [ k ] = E \{ {u}^{*} [ k ] \cdot \tilde{r} [ {k}_{0} + l \cdot M ] \} = {γ}_{b} \cdot \tilde{b} \cdot {\tilde{R}}_{c} ( ( {k}_{0} + l \cdot M - k ) \cdot {T}_{s} ) & ( u )\end{matrix}$$

where δₗₘ is the Kronecker delta function and \tilde{R}_{c}(τ) is the auto-correlation of the fading channel after compensating for the frequency of the direct path or:

$${\tilde{R}}_{c} ( τ ) = \frac{{K}_{rician}}{{K}_{rician} + 1} + \frac{1}{{K}_{rician} + 1} \cdot {ⅇ}^{- j2π0 .7 {f}_{D} τ} \cdot {J}_{0} ( 2 π {f}_{D} τ ) \qquad ( v )$$

The factor 0.25 in the right-hand side of relation (t) results from the fact the each reference symbol is composed of four individual bits for this specific burst type. Note that the auto-correlation matrix R is independent of the time index k and an inverse thereof is pre-computed once.

Scheme 2: Linear Interpolator and Block Phase Estimation with Decision Feedback

This scheme is shown in Background Art FIG. 13 and is similar to the Wiener-based scheme shown in Background Art FIG. 12 and described above except that this scheme uses piece-wise linear interpolation [9] in place of Wiener interpolation in the channel estimator and interpolator 1304. This scheme is simpler and involves far less processing than the scheme of Background Art FIG. 12.

Scheme 3: Demodulator Based on Fuzzy Adaptive Filter (FAF) and Decision Feedback Fuzzy Adaptive Filters

A block diagram of this scheme is given in FIG. 2, wherein the elements 1202, 1208, 1210, 1212, 1214 and 1216 operate in as similar manner as the corresponding elements described with respect to Background Art FIGS. 12 and 13 and a description thereof will be omitted herewith for the sake of brevity. A fuzzy logic system (FLS) is described by fuzzy IF-THEN rules that represent I/O relations of a system. For a FLS with M rules, each having p antecedents, the ith rule R¹ is expressed as:

IF x₁ is F₁^{l} and x₂ is F₂^{l} and . . . and xₚ is Fₚ^{l} THEN yₗ=cₗ

where i=1, 2, . . . , M; yₗ is the output of the ith rule; and, Fₖ^{l} (k=1, 2, . . . , p) are fuzzy sets (we use Gaussian membership functions (MF) in this report). Given an input (x₁, x₂, . . . , xₚ), the final output of the FLS is inferred as:

$$y = {\sum }_{i = 1}^{M} {f}_{i} {y}_{i} \qquad ( 4 )$$

where ƒₗ are rule firing strengths defined as:

$${f}_{i} = {\prod }_{k = 1}^{p} {μ}_{{F}_{k}^{i}} ( {x}_{k} ) , \qquad ( 5 )$$

if we use product t-norm.

When Gaussian MFs are used, i.e.:

$${μ}_{{F}_{k}^{i}} ( {x}_{k} ) = exp [ - \frac{1}{2} {( \frac{{x}_{k} - {m}_{k}^{i}}{{σ}_{k}^{i}} )}^{2} ] , \qquad ( 6 )$$

then (4) can be expressed as:

$$y = {\sum }_{i = 1}^{M} {y}_{i} {\prod }_{k = 1}^{p} exp [ - \frac{1}{2} {( \frac{{x}_{k} - {m}_{k}^{i}}{{σ}_{k}^{i}} )}^{2} ] \qquad ( 7 )$$

We design the following rules:

Rⁱ: IF the real part of r(k) is F₁^{l} and the imaginary part of r(k) is F₂^{l} THEN yₗ=cₗ

where F₁^{l} and F₂^{l} are Gaussian membership functions; cₗ is a complex value which can take 1+j, −1+j, −1−j, or −1−j (actually they are 1, j, −1, or −j, but for convenience of hard decision, we rotate them by π/4) based on the category of reference symbols; and i=0, 1, 2, 3.

We represent the Gaussian membership function as:

$${μ}_{{F}_{n}^{i}} ( x ) = exp [ - \frac{1}{2} {( \frac{x - {m}_{n}^{i}}{{σ}_{n}^{i}} )}^{2} ] \qquad ( 8 )$$

where n=1, 2.

Determination of Parameters in Fuzzy Rules (Element 206)

To determine the mean and standard deviation (std) of the Gaussian MF, some statistical knowledge of each symbol in QPSK constellation is desired. We only have two symbol patterns, 1 and −1 in reference symbols, i.e., u(k)ε{1, −1} for reference symbols where kε{0, 1, 9, 10, 29, 30, . . . , 109, 110} equivalent to:

$$\frac{r ( k )}{u ( k )} = b ( k ) + \frac{n ( k )}{u ( k )} \qquad ( 9 )$$

We let u₁(i)ε{1, j, −1, −j} (i=0, 1, 2, 3), multiply u₁(i) to both sizes of (9), then:

$$\frac{{u}_{1} ( i )}{u ( k )} r ( k ) = b ( k ) {u}_{1} ( i ) + \frac{{u}_{1} ( i )}{u ( k )} n ( k ) \qquad ( 10 )$$

We let:

$${n}_{1} ( i , k ) = \frac{{u}_{1} ( i )}{u ( k )} n ( k ) \qquad ( 11 )$$

Since n(k) is an AWGN, so it's easy to prove that for a fixed value of i, n₁(i, k) is also an AWGN with the same mean and std as n(k). Combining (10) and (11), we get:

$$\frac{{u}_{1} ( i )}{u ( k )} r ( k ) = b ( k ) {u}_{1} ( i ) + {n}_{1} ( i , k ) \qquad ( 12 )$$

Observe that the right side of (12), b(k) is a channel gain, u₁(i) is one QPSK symbol, and n₁(i, k) is an AWGN, so we have derived one method to obtain the distorted received signal should a different reference symbols are sent instead of the current one. We let:

$${r}^{′} ( i , k ) = \frac{{u}_{1} ( i )}{u ( k )} r ( k ) \qquad ( 13 )$$

In (13), for each value of k (i.e., 12 different values of k), we have 4 u₁(i) values. By this means, we can obtain 48 (i.e., 4×12) distorted signals, in which 12 of them belongs to the case when the transmitted signal is 1, 12 of them belongs to the case when the transmitted signal is j, 12 of them belongs to the case when the transmitted signal is −1, and 12 of them belongs to the case when the transmitted signal is −j. Computing the mean and std of r₁(0, k), kε{0, 1, 9, 10, 29, 30, . . . , 109, 110} we can obtain the parameters for the Gaussian membership function F₁⁰ and F₂⁰, and the consequent parameter cₗ=1+j. Similarly, we can determine the parameters for the other 3 rules.

Based on channel estimation 204, we can obtain the channel gain in one burst, by computing the mean, mᵣ+jmₗ, and std, σᵣ+jσₗ, of the channel gain, then the means of the four clusters are mᵣ+jmₗ, (mᵣ+jmₗ)j, −(mᵣ+jmₗ), and −(mᵣ+jmₗ). Based on the real and imaginary parts of all these means and stds, the Gaussian membership functions in each rule can be determined. Then decision feedback (DF, elements 216, 214 and 212) is used to update the channel gain, which can be used to update the mean and std for the Gaussian membership functions. This approach combines the advantages of both FAF and DF.

The scheme of FIG. 2 differs from the first two schemes of the Background Art FIGS. 12 and 13 in that there is no interpolation of the channel gain estimates based on reference symbols in the channel estimation 204. Instead use is made of the novel Fuzzy adaptive filter parameter determination 206 to obtain signal samples used for the detection 208.

A third scheme, a FAF only scheme, is similar to the scheme of FIG. 2, except that no decision feedback (elements 216, 214 and 212) is employed. A fourth scheme, a FAF only with multi-burst detection scheme is also possible. Such a scheme poses an interesting question: What can be gained with the use of burst aggregation based detection relative to single-burst detection? The motivation for this is based on the new physical layer baseline design [7, 8] in which the use of variable FEC in the Forward link and corresponding L1 burst aggregation is specified.

Simulation Model

Introduction

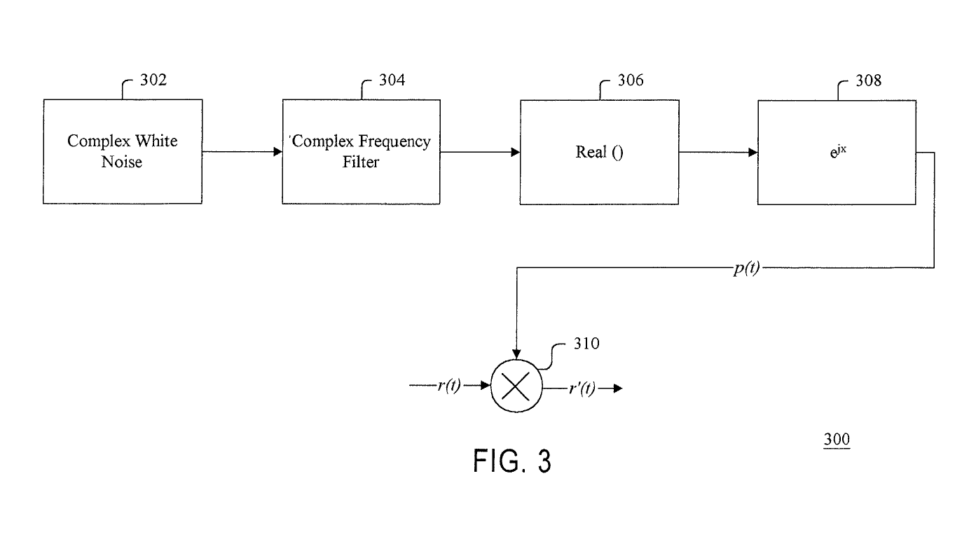

The performance of the above-noted schemes was simulated entirely in base-band using equivalent base-band models and will now be discussed with reference to FIGS. 3-10.

Receiver Impairments [11]

The effects of phase noise, IQ mismatches and Adjacent Channel Interference (ACI) was tested on the Packet Data Channel (PDCH). Blocks were created to simulate each one of the impairments. In the following, a brief discussion of some of the impairments considered is given. The levels of the various impairments were based on existing in-house data and in many cases represent nominal-to-worst case levels.

Phase Noise

Phase noise is the characterization of the degree to which an oscillating source produces the same frequency throughout a period of time. A widely used model for the phase noise [9] is given in FIG. 3 and includes a complex white noise source 320, a complex frequency filter 304, sections 306 and 308 and combiner 310. The general idea is to generate a random variable with properties close to the phase noise p(t) that we want to model. Assuming the process to be Gaussian, we modify its average power and power spectral density to match those of the phase noise of interest.

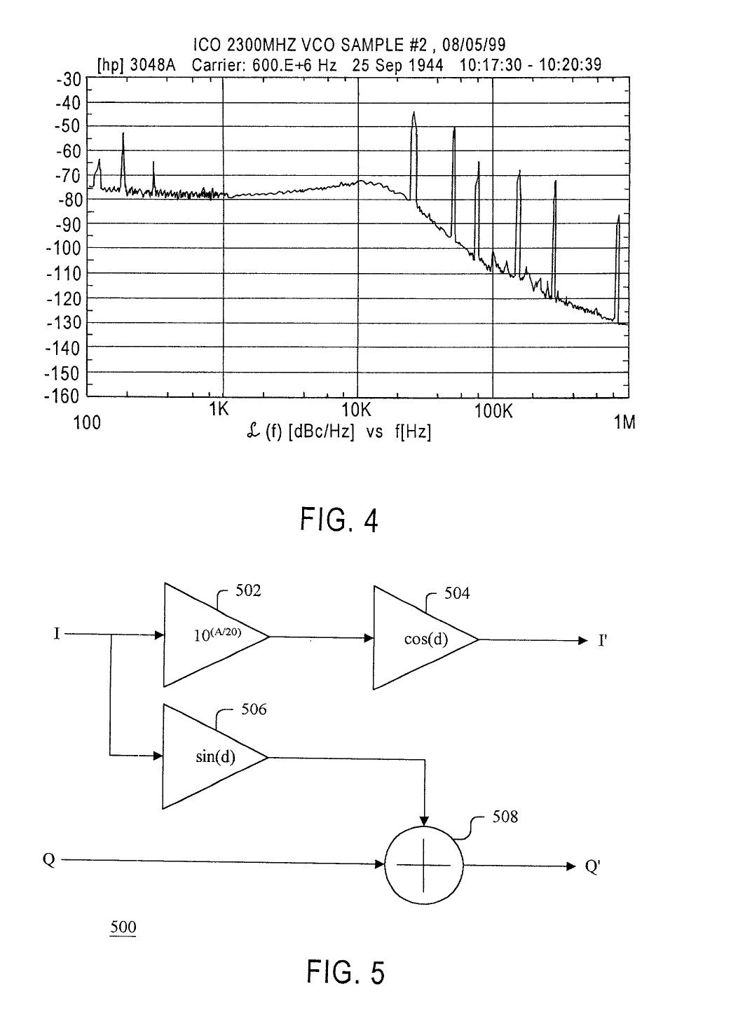

In the present invention, the measured frequency response given in FIG. 4, which represent the response of a VCO, to filter the Gaussian process is used. Then its average power is modified to adjust it to the phase noise RMS value given of 3° [11].

IQ Mismatch

IQ mismatch occurs when the gain in the I and Q channels is not the same or when the phase between the I and Q signals is not 90°. A model used for IQ mismatch is given in FIG. 5 and includes elements 502-508. In FIG. 5, IQ amplitude imbalance equals “A” dB and the IQ phase mismatch equals +/− “d” degrees. In the present invention, it is assumed that the values of IQ mismatch are as follows [11]: (i) IQ amplitude imbalance=0.12 dB and (ii) IQ phase mismatch=1°.

Adjacent Channel Interference

The selectivity requirement for the PDCH has not yet been defined. The same levels as defined in the existing Air Interface ICO 05.05.A1 ver 4.5 [10] are used. These are summarized in Table 2 below.

TABLE 2
Reference interference performance

| Frequency offset from | |
|---|---|
| Center (kHz) | Interferer |
| 0 | −15 dBc |
| 75 (Adjacent) | +9 dBc |
| 150 (Bi-Adjacent) | +20 dBc* |

Sensitivity to Timing Errors

The sensitivity of the coherent demodulator to residual timing errors is also investigated. This is an open-loop system without any timing tracking and correction mechanism in the receiver. The target is not to allow more than 0.05 dB degradation at the demodulation due to this effect.

Sensitivity to Frequency Errors

The sensitivity of the coherent demodulator to residual frequency error is also investigated. This is an open loop system without any frequency tracking and correction mechanism in the receiver. The target is not to allow more than 0.05 dB degradation of the demodulation due to this effect.

DC Offset

DC offset is defined here as the linear drift in the I and Q signal voltage at the output of the I/Q demodulator chip. This can be periodically reset with maximum reset rate of once per burst. The model for the DC offset contains a ramp voltage added to the baseband I and Q samples. The period of the ramp is equal to the length of the transmitted bursts. The DC offset of 2.86 mV/ms (for 1V peak) considered is obtained from preliminary measurements in the lab.

Results

In the results reported here the performance was assessed in terms of raw Bit Error Error Rate (BER) vs. Signal-to-Noise Ratio (SNR), given in terms of Eb/No (dB). BER reference points of 2% for static and 4% for fading were used as threshold operating points for evaluating results.

Performance with No Receiver Impairments

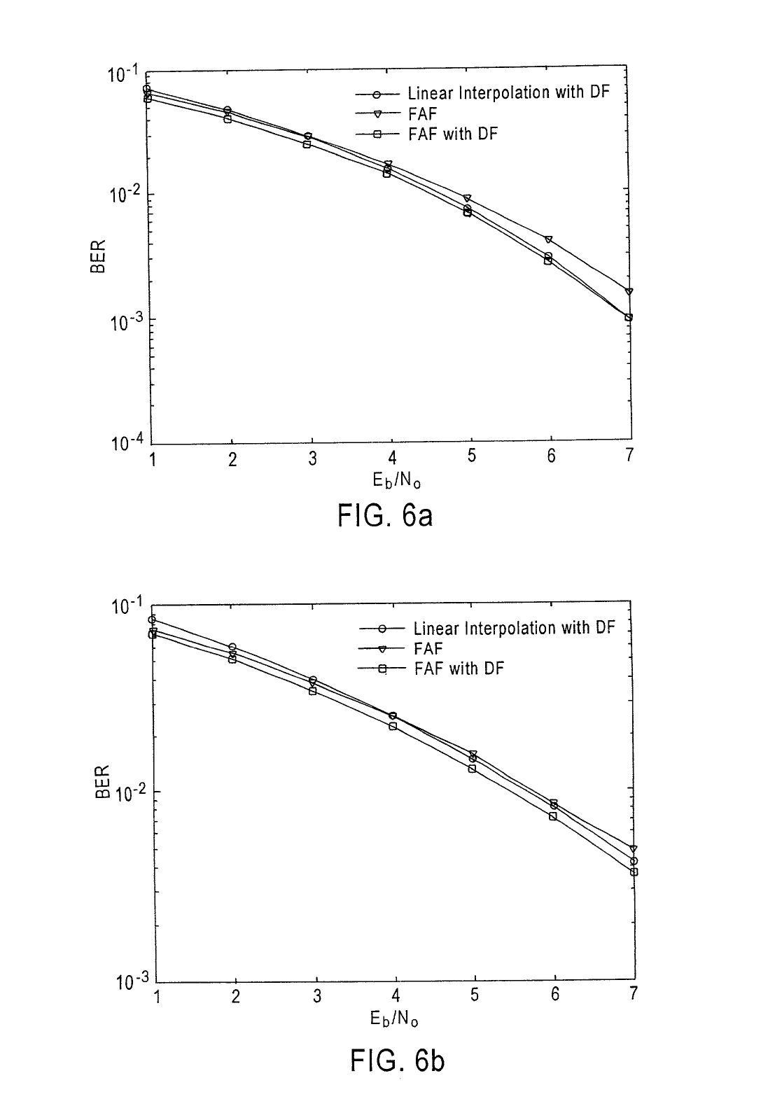

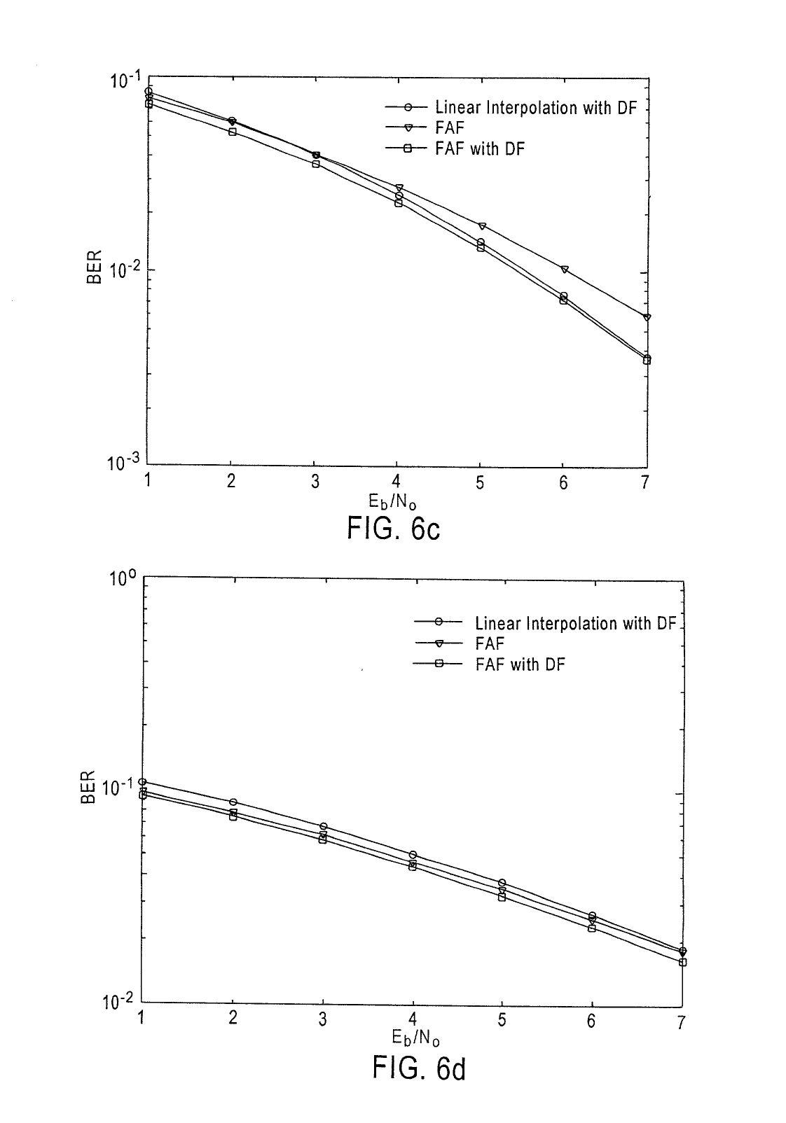

FIGS. 6a-6d are graphs illustrating the performance of the demodulator of FIG. 2 with no receiver impairments as compared to some of the other schemes, according to the present invention. In FIG. 6a, the performance is compared in a Static AWGN channel. In FIG. 6b, the performance is compared in a Fading channel, with K=12 dB, fd=20 Hz and AWGN. In FIG. 6c, the performance is compared in a Fading channel, with K=12 dB, fd=200 Hz and AWGN. In FIG. 6d the performance is compared in a Fading channel, with K=9 dB, fd=1 Hz and AWGN.

Performance with Receiver Impairments

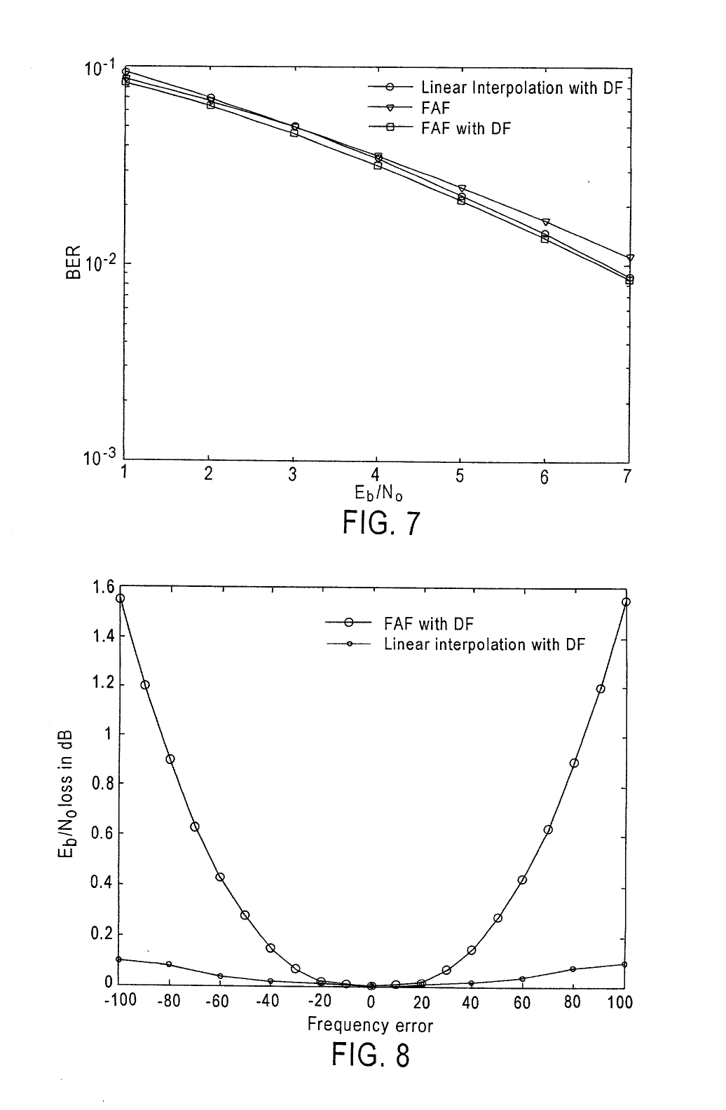

FIG. 7 is graph illustrating the performance of the demodulator of FIG. 2 with no receiver impairments as compared to some of the other schemes, according to the present invention. In FIG. 7, the performance is compared in a Fading channel, with K=12 dB and fd=20 Hz and with all channel impairments (i.e., ACI, phase noise, IQ mismatch, timing offset, frequency errors, and DC offset).

Sensitivity to Frequency Errors

FIG. 8 is a graph illustrating the sensitivity of the demodulator of FIG. 2 to frequency errors as compared to some of the other schemes, according to the present invention. In FIG. 8, the sensitivity to frequency errors is compared with SNR degradation due to frequency errors (i.e., with a sampling frequency of 54,000 Hz) for FAF with DF. From FIG. 7, it is noted that a 35 Hz frequency error can introduce 0.1 dB degradation for FAF with DF and a 100 Hz frequency error can lead to 0.1 dB degradation for linear interpolation with DF.

Sensitivity to Timing Errors

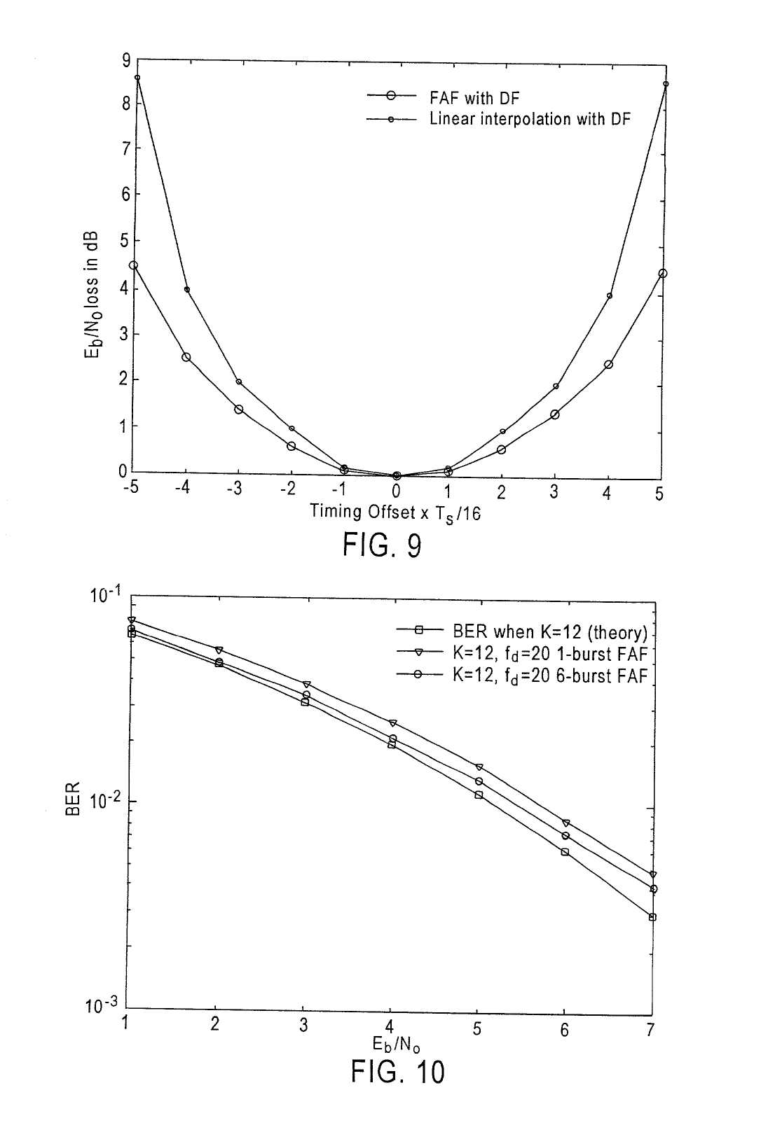

FIG. 9 is a graph illustrating the sensitivity of the demodulator of FIG. 2 to timing errors as compared to some of the other schemes, according to the present invention. In FIG. 9, the sensitivity to timing errors is compared with SNR degradation due to timing offset (i.e., where Tₛ is symbol period and Tₛ=1/54,000). From FIG. 9, it is noted that a T_{s/}32 timing offset can introduce 0.1 dB degradation for FAF with DF and linear interpolation with DF.

Relative Performance of Multi-burst vs. Single Burst Detection

FIG. 10 is a graph illustrating the performance of the demodulator of FIG. 2 in single versus multi-burst detection, according to the present invention. In FIG. 10, the performance comparison of 6-burst FAF and 1-burst FAF demodulators is shown. From FIG. 10, it is noted that a 0.4 dB gain can be achieved when 6 consecutive bursts are jointly used for demodulation.

Summary and Conclusion

The performance results of the various demodulator schemes are summarized in Table 3 below.

TABLE 3
Summary of results in Fading

| | | K = 9 dB, | K = 12 dB, | K = 12 dB, |
|---|---|---|---|---|
| Demodulator | | Fd = 1 Hz, | Fd = 20 Hz, | Fd = 200 Hz, |
| Scheme | Static 2% BER | 4% BER | 4% BER | 4% BER |
| Wiener with | Eb/No, dB = 3.65 | Eb/No, dB = 4.55 | Eb/No, dB = 2.85 | Eb/No, dB = 2.95 |
| feedback | | | | |
| Linear with | Eb/No, dB = 3.65 | Eb/No, dB = 4.55 | Eb/No, dB = 2.85 | Eb/No, dB = 2.95 |
| feedback | | | | |
| FAF with | Eb/No, dB = 3.4 | Eb/No, dB = 4.3 | Eb/No, dB = 2.55 | Eb/No, dB = 2.65 |
| feedback | | | | |
| FAF only | Eb/No, dB = 3.7 | Eb/No, dB = 4.85 | Eb/No, dB = 2.80 | Eb/No, dB = 2.98 |

The results summarized in Table 3 above suggest that the Fuzzy Adaptive Filter (FAF) with decision feedback demodulator 200 scheme of FIG. 2 gives the best performance over the variety of channels tested and with approximately 0.3 dB improvement over the Wiener and linear interpolator based schemes. The FAF scheme however is more sensitive to the effects of residual frequency errors. A significant performance improvement, up to 0.4 dB, can be gained with the use of burst aggregation (×6) for channel estimation compared with no burst aggregation. All the schemes showed a SNR degradation to the effects of receiver impairments of approximately 1.2 dB.

The present invention stores information relating to various processes described herein. This information is stored in one or more memories, such as a hard disk, optical disk, magneto-optical disk, RAM, etc. One or more databases, such as the databases within the systems 104, 108 and 112, etc., may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 11, for example.

The previously described processes include appropriate data structures for storing data collected and/or generated by the processes of the system 100 of FIG. 1 in one or more databases thereof. Such data structures accordingly will includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The present invention (e.g., as described with respect to FIGS. 1-10) may be implemented by the preparation of application-specific integrated circuits or by interconnecting an appropriate network of conventional component circuits, as will be appreciated by those skilled in the electrical art(s). In addition, all or a portion of the invention (e.g., as described with respect to FIGS. 1-10) may be conveniently implemented using one or more conventional general purpose computers, microprocessors, digital signal processors, micro-controllers, etc., programmed according to the teachings of the present invention (e.g., using the computer system of FIG. 11), as will be appreciated by those skilled in the computer and software art(s). Appropriate software can be readily prepared by programmers of ordinary skill based on the teachings of the present disclosure, as will be appreciated by those skilled in the software art. Further, the present invention may be implemented on the World Wide Web (e.g., using the computer system of FIG. 11).

FIG. 11 illustrates a computer system 1101 upon which the present invention (e.g., systems 104, 108, 112, etc.) can be implemented. The present invention may be implemented on a single such computer system, or a collection of multiple such computer systems. The computer system 1101 includes a bus 1102 or other communication mechanism for communicating information, and a processor 1103 coupled to the bus 1102 for processing the information. The computer system 1101 also includes a main memory 1104, such as a random access memory (RAM), other dynamic storage device (e.g., dynamic RAM (DRAM), static RAM (SRAM), synchronous DRAM (SDRAM)), etc., coupled to the bus 1102 for storing information and instructions to be executed by the processor 1103. In addition, the main memory 1104 can also be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), electrically erasable PROM (EEPROM), etc.) coupled to the bus 1102 for storing static information and instructions.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices 1118, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, satellite communications transceiver functions, demodulator 200 functions, etc.

The computer system 1101 may also include a display controller 1109 coupled to the bus 1102 to control a display 1110, such as a cathode ray tube (CRT), liquid crystal display (LCD), active matrix display, plasma display, touch display, etc., for displaying or conveying information to a computer user. The computer system includes input devices, such as a keyboard 1111 including alphanumeric and other keys and a pointing device 1112, for interacting with a computer user and providing information to the processor 1103. The pointing device 1112, for example, may be a mouse, a trackball, a pointing stick, etc., or voice recognition processor, etc., for communicating direction information and command selections to the processor 1103 and for controlling cursor movement on the display 1110. In addition, a printer may provide printed listings of the data structures/information of the system shown in FIGS. 1-6, or any other data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. Execution of the arrangement of instructions contained in the main memory 1104 causes the processor 1103 to perform the process steps described herein. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

Stored on any one or on a combination of computer readable media, the present invention includes software for controlling the computer system 1101, for driving a device or devices for implementing the invention, and for enabling the computer system 1101 to interact with a human user (e.g., a user of the systems 104, 108, 112, etc.). Such software may include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention may be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention may be distributed for better performance, reliability, and/or cost.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a digital subscriber line (DSL) card or modem, an integrated services digital network (ISDN) card, a cable modem, a telephone modem, etc., to provide a data communication connection to a corresponding type of telephone line. As another example, communication interface 1113 may be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 1113 sends and receives electrical, electromagnetic, or optical signals that carry digital data streams representing various types of information. Further, the communication interface 1113 can include peripheral interface devices, such as a Universal Serial Bus (USB) interface, a PCMCIA (Personal Computer Memory Card International Association) interface, etc.

The network link 1114 typically provides data communication through one or more networks to other data devices. For example, the network link 1114 may provide a connection through local area network (LAN) 1115 to a host computer 1117, which has connectivity to a network 1116 (e.g. a wide area network (WAN) or the global packet data communication network now commonly referred to as the “Internet”) or to data equipment operated by service provider. The local network 1115 and network 1116 both use electrical, electromagnetic, or optical signals to convey information and instructions. The signals through the various networks and the signals on network link 1114 and through communication interface 1113, which communicate digital data with computer system 1101, are exemplary forms of carrier waves bearing the information and instructions.

The computer system 1101 can send messages and receive data, including program code, through the network(s), network link 1114, and communication interface 1113. In the Internet example, a server (not shown) might transmit requested code belonging an application program for implementing an embodiment of the present invention through the network 1116, LAN 1115 and communication interface 1113. The processor 1103 may execute the transmitted code while being received and/or store the code in storage devices 1107 or 1108, or other non-volatile storage for later execution. In this manner, computer system 1101 may obtain application code in the form of a carrier wave. With the system of FIG. 11, the present invention may be implemented on the Internet as a Web Server 1101 performing one or more of the processes according to the present invention for one or more computers coupled to the Web server 1101 through the network 1116 coupled to the network link 1114.

The term “computer readable medium” as used herein refers to any medium that participates in providing instructions to the processor 1103 for execution. Such a medium may take many forms, including but not limited to, non-volatile media, volatile media, transmission media, etc. Non-volatile media include, for example, optical or magnetic disks, magneto-optical disks, etc., such as the hard disk 1107 or the removable media drive 1108. Volatile media include dynamic memory, etc., such as the main memory 1104. Transmission media include coaxial cables, copper wire, fiber optics, including the wires that make up the bus 1102. Transmission media can also take the form of acoustic, optical, or electromagnetic waves, such as those generated during radio frequency (RF) and infrared (IR) data communications. As stated above, the computer system 1101 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer connected to either of networks 1115 and 1116. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

The demodulator 200, according to the present invention, advantageously, (i) employs a small number of training data (e.g, 12 QPSK symbols in one 120-symbol burst) with (ii) a limited pattern (e.g., 00 followed by 11, not 01 and 10) and (iii) provides adequate demodulator performance in a Rician fading channel, which has lots of channel impairments (e.g., adjacent channel interferences (ACI), phase noise, IQ mismatch, timing and frequency errors, DC offset, etc.), as compared to conventional demodulator techniques. The present invention applies a fuzzy adaptive filter (FAF) to fading channel demodulation. This approach is much simpler than existing demodulator schemes. The present invention combines the advantages of FAF and decision feedback and achieves better performance (e.g., 0.3 dB gain) when compared to existing schemes, such as linear interpolation with decision feedback, etc.

The present invention breaks limitations on the number of unique words (i.e., training sequences) and non-uniform pattern of the unique words found in conventional demodulator techniques. The demodulator 200 of the present invention may be used in a packet data system, such as a packet data satellite communications system, etc. The demodulator 200 of the present invention may be used in a device, such as a Bluetooth [12] repeater, PDA, etc. Since the demodulator 200 of the present invention typically obtains a 0.3 dB gain as compared to a conventional demodulator, the demodulator 200 of the present invention may help save millions of dollars in the satellite communications market. Other potential applications of the demodulator 200 of the present invention include demodulators for other QPSK communication systems.

Although the present invention is described in terms of a demodulator used in a satellite communications system, the present invention is applicable to other communications systems that may employ a demodulator, such digital video broadcasting (DVB) communications systems, terrestrial broadcast communications systems, cellular communications systems, QPSK communications systems, etc., as will be appreciated by those skilled in the relevant art(s).

While the present invention has been described in connection with a number of embodiments and implementations, the present invention is not so limited but rather covers various modifications and equivalent arrangements, which fall within the purview of the appended claims.

### LIST OF REFERENCES

[1] L. -X. Wang and J. M. Mendel, “Fuzzy adaptive filters, with application to nonlinear channel equalization”, IEEE Trans Fuzzy Systems, vol. 1, pp. 161-170, August 1993.

[2] P. Sarwal and M. D. Srinath, “A fuzzy logic system for channel equalization”, IEEE Trans Fuzzy Systems, vol. 3, pp. 246-249, May 1995.

[3] K. Y. Lee, “Complex fuzzy adaptive filters with LMS algorithm”, IEEE Trans Signal Processing, vol. 44, pp. 424-429, February 1996.

[4] S. K. Patra and B. Mulgrew, “Efficient architecture for Bayesian equalization using fuzzy filters”, IEEE Trans Circuits and Systems II, vol. 45, pp. 812-820, July 1998.

[5] Q. Liang and J. M. Mendel, “Equalization of nonlinear time-varying channels using type-2 fuzzy adaptive filters”, IEEE Trans. Fuzzy Systems, vol. 8, no. 5, pp. 551-563, October 2000.

[6] Q. Liang and J. M. Mendel, “Overcoming time-varying co-channel interferenc using type-2 fuzzy adaptive filters”, IEEE Trans on Circuits and Systems, II, vol. 47, no. 12, pp. 1419-1428, December 2000.

[7] ICO System Design Book, version 3.0—Section 3, 28 Nov. 2000.

[8] ICO CLDT Radio team, “Radio static Layer1 baseline”, Oct. 13, 2000

[9] B. Beidas, “An improved channel estimation algorithm for ICO downlink traffic bursts”, Internal Memorandum, Hughes Network Systems, May 99.

[10] A. Viterbi, and A. Viterbi, “Nonlinear estimation of PSK-modulated carrier phase with application to burst digital transmission”, IEEE Trans Information Theory, vol. 29, no. 4, July 1983.

[11] Jeruchin, Michael C., Balaban, Philip and Shanmugan, K. Sam, Simulation of Communication Systems. Plenum Press, New York, 1992.

[12] See, e.g., Bluetooth documentation available on the World Wide Web at Bluetooth.com.

What is claimed is:

1. A demodulator for use in a communications channel, comprising:
a channel estimator section configured to receive a modulated signal over said communications channel and generate reference symbols based on said modulated signal;
a fuzzy adaptive filter (FAF) parameter determination section coupled to said channel estimator section and configured to receive said modulated signal and said reference symbols and generate signal samples based on said modulated signal and said reference symbols; and
a detector section coupled to said FAF parameter determination section and configured to receive said signal samples and generate a soft decision signal and a hard decision signal based on said signal samples.

2. The demodulator of claim 1, further comprising:
a mapping section coupled to said detector section and configured to receive said hard decision signal and generate a mapping signal based on said hard decision signal;
a modulation removal section coupled to said mapping section and configured to receive said mapping signal and said modulated signal and generate a modulation removal signal based on said mapping signal and said modulated signal;
a phase estimation section coupled between said FAF parameter determination section and said modulation removal section and configured to receive said modulation removal signal and generate a phase estimation signal based on said modulation removal signal,
wherein said FAF parameter determination section is configured to generate said signal samples based on said modulated signal, said reference symbols and said phase estimation signal.

3. The demodulator of claim 1, further comprising:
a matched filter section coupled between said communications channel and said channel estimator section and said FAF parameter determination section; and
a buffer section coupled between said matched filter section and said modulation removal section.

4. The demodulator of claim 1, wherein said communications channel comprises a satellite communications channel.

5. The demodulator of claim 4, wherein said satellite communications channel comprises a satellite downlink communications channel.

6. The demodulator of claim 1, wherein said modulated signal comprises a Quadrature Phase Shift Keying (QPSK) modulated signal and said detector section comprises a QPSK detector.

7. The demodulator of claim 2, wherein said modulated signal comprises a quadrature phase shift keying (QPSK) modulated signal and said mapping section comprises a QPSK mapper.

8. The demodulator of claim 1, wherein said phase estimation section comprises a block phase estimator (BPE).

9. The demodulator of claim 1, wherein said communications channel comprises one of a satellite communications channel, digital video broadcasting (DVB) communications channel, a terrestrial broadcast communications channel, a cellular communications channel and a quadrature phase shift keying (QPSK) communications channel.

10. The demodulator of claim 1, wherein said demodulator is included in a device comprising one of a repeater, a personal digital assistant (PDA), a personal computer, a television, an Internet appliance, a cellular phone and a set-top box.

11. The demodulator of claim 1, wherein said device comprises a Bluetooth-enabled device.

12. A demodulation method for use in a communications channel, comprising:
receiving a modulated signal over said communications channel and generating reference symbols based on said modulated signal via a channel estimator section;
receiving said modulated signal and said reference symbols and generating signal samples based on said modulated signal and said reference symbols via a fuzzy adaptive filter (FAF) parameter determination section coupled to said channel estimator section; and
receiving said signal samples and generating a soft decision signal and a hard decision signal based on said signal samples via a detector section coupled to said FAF parameter determination section.

13. The demodulation method of claim 12, further comprising:
receiving said hard decision signal and generating a mapping signal based on said hard decision signal via a mapping section coupled to said detector section;
receiving said mapping signal and said modulated signal and generating a modulation removal signal based on said mapping signal and said modulated signal via a modulation removal section coupled to said mapping section;
receiving said modulation removal signal and generating a phase estimation signal based on said modulation removal signal via a phase estimation section coupled between said FAF parameter determination section and said modulation removal section; and
generating said signal samples based on said modulated signal, said reference symbols and said phase estimation signal via said FAF parameter determination section.

14. The demodulation method of claim 12, further comprising:
coupling a matched filter section between said communications channel and said channel estimator section and said FAF parameter determination section; and
coupling a buffer section between said matched filter section and said modulation removal section.

15. The demodulation method of claim 12, further comprising configuring said communications channel as a satellite communications channel.

16. The demodulation method of claim 15, further comprising configuring said satellite communications channel as a satellite downlink communications channel.

17. The demodulation method of claim 12, further comprising configuring said modulated signal as a Quadrature Phase Shift Keying (QPSK) modulated signal and said detector section as a QPSK detector.

18. The demodulation method of claim 13, further comprising configuring said modulated signal as a quadrature phase shift keying (QPSK) modulated signal and said mapping section as a QPSK mapper.

19. The demodulation method of claim 12, further comprising configuring said phase estimation section as a block phase estimator (BPE).

20. The demodulation method of claim 12, further comprising configuring said communications channel as one of a satellite communications channel, digital video broadcasting (DVB) communications channel, a terrestrial broadcast communications channel, a cellular communications channel and a quadrature phase shift keying (QPSK) communications channel.

21. The demodulation method of claim 12, further comprising configuring said demodulator to be included in a device comprising one of a repeater, a personal digital assistant (PDA), a personal computer, a television, an Internet appliance, a cellular phone and a set-top box.

22. The demodulation method of claim 12, further comprising configuring said device as a Bluetooth-enabled device.

23. A computer-readable medium carrying one or more sequences of one or more instructions for a demodulation method, the one or more sequences of one or more instructions including instructions which, when executed by one or more processors, cause the one or more processors to perform the steps recited in any one of claims 12-22.

24. A demodulator apparatus for use in a communications channel, comprising:
a channel estimation means for receiving a modulated signal over said communications channel and generating reference symbols based on said modulated signal;
a fuzzy adaptive filter (FAF) parameter determination means coupled to said channel estimation means for receiving said modulated signal and said reference symbols and generating signal samples based on said modulated signal and said reference symbols; and
a detection means coupled to said FAF parameter determination means for receiving said signal samples and generating a soft decision signal and a hard decision signal based on said signal samples.
